(19) United States
(12) Patent Application Publication
(10) Pub. No.: US 2026/0148257 A1
(43) Pub. Date: May 28, 2026

(54) SYSTEM AND METHODS FOR INTERACTIVE AD BRAND TARGETING

(71) Applicant: Comcast Cable Communications, LLC, Philadelphia, PA (US)

(72) Inventors: Kan XU, Beijing (CN); Cuiwei LI, Beijing (CN); Wenjing LU, Beijing (CN); Xue ZHANG, Beijing (CN); Qiang WANG, Beijing (CN)

(21) Appl. No.: 18/961,000

(22) Filed: Nov. 26, 2024

Related U.S. Application Data
(63) Continuation of application No. PCT/CN2023/139166, filed on Dec. 15, 2023.

(51) Int. Cl. G06Q 30/0251; G06V 10/70; H04N 21/2387; H04N 21/81

(52) U.S. Cl. CPC G06Q 30/0251; G06V 10/70; H04N 21/2387; H04N 21/812

(57) ABSTRACT

System and methods are disclosed for interactive advertisement brand targeting related to recently viewed objects within content assets. Advertisements, and/or other supplemental content, related to recently viewed content tend to be the most impressionable and relevant for the viewer of the content. By recognizing objects within the recently viewed content and mapping these objects to advertisements related to such objects, advertisement campaigns can increase the reach rate and make a better ad experience. Thus, when a user watching a video pauses the video, for example, an advertisement may be displayed related to an object in the frame of the paused video.

### CROSS-REFERENCE TO RELATED APPLICATIONS

This application is a continuation of International Patent Application No. PCT/CN2023/139166, filed Dec. 15, 2023, the contents of which are hereby incorporated by reference in its entirety.

### BACKGROUND

Typically, advertisement campaigns which use product placement techniques, such as embedding advertisements in content assets, are created to drive attention to a new product or service. For example, an advertisement campaign may buy time slots on a social media application near the release of a new movie in order to promote that movie. However, the most impressionable and relevant advertisements tend to be advertisements related to objects or things a user recently viewed. For example, after a coffee shop scene in a video, a user will be more interested in an advertisement about coffee than an advertisement about an unrelated new product release. Therefore, new ways to embed targeted advertisements associated with recently viewed objects within content assets are needed.

### SUMMARY

Systems and methods are disclosed for interactive advertisement brand targeting related to recently viewed objects within content assets. When a pause in a video is detected on a user device (e.g., when a user presses the pause button), a request for an advertisement may be sent. The paused frame may be analyzed to identify one or more objects (e.g., a coffee cup) that appear in the paused frame or a recently played frame. Alternatively, a manifest file may be utilized, which maps each object to each frame in the video in which that object appears. An advertisement may be selected based on one of the identified objects appearing in the paused frame (or recently played frame) and displayed for presentation on the user device. If there are multiple objects identified, the advertisement may be selected based on additional information, such as a current advertising campaign related to a specific brand, how recent an advertisement has been displayed, and/or the like. As a result, the user device may receive more relevant and interactive advertisements related to recently viewed objects within the content being viewed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system.

FIG. 2 shows an example of a frame of content.

FIG. 3 shows an example flow diagram of an example method.

FIG. 4 shows an example flow diagram of an example method.

FIG. 5 shows an example flow diagram of an example method.

FIG. 6 shows an example flow diagram of an example method.

FIG. 7 shows an example method.

FIG. 8 shows an example method.

FIG. 9 shows an example method.

FIG. 10 shows an example architecture.

### DETAILED DESCRIPTION OF ILLUSTRATIVE EMBODIMENTS

Disclosed herein are systems and methods for interactive advertisement brand targeting related to recently viewed objects within content assets. These systems and methods may also be adopted for use as interactive advertisement brand targeting related to recently listened phrases in audio content assets as well. Some advertisement targeting techniques focus on audience characteristics, such as geographic-based information and demographic-based information, and/or general information regarding the content being watched, such as the genre of content. Advertisement campaigns may target advertisements based on audience characteristics, such as geographic-based information and demographic-based information, or general information regarding the content being watched, such as the genre of content. If the content contains objects that can be recognized and mapped to advertisements, then additional information can be utilized for advertisement decision making.

Advertisements, and/or other supplemental content, related to recently viewed content tend to be the most impressionable and relevant for the viewer of the content. The content may be video, audio, or any other content asset. For example, recently listened to audio frames of podcasts can be analyzed for certain words or phrases related to advertisements. By recognizing objects within the recently viewed or listened content and mapping these objects or phrases to advertisements related to such objects or phrases, advertisement campaigns can increase the reach rate and make a better ad experience. Thus, when a user watching a video presses pause, an advertisement may be displayed related to an object in the frame of the paused video. For example, if the paused frame contains a coffee cup, an advertisement for a coffee shop may be displayed over the paused video. Alternatively, some content may have certain advertisement slots that display an advertisement at fixed intervals. Instead of recognizing objects within a paused frame, the objects within the last frame before the advertisement slot may be analyzed and mapped to an advertisement. In either scenario, if there are multiple objects identified, the advertisement may be selected based on additional information, such as a current advertising campaign related to a specific brand, how recent an advertisement has been displayed, and/or the like. Additionally, it may be too taxing on a system to analyze a frame of content for objects in real time. A content provider may provide a manifest that maps each object in each frame of the content to all available advertisements in order to more efficiently display the relevant advertisement, which may provide more flexible and relevant interactive advertisement brand targeting, based on the video content itself.

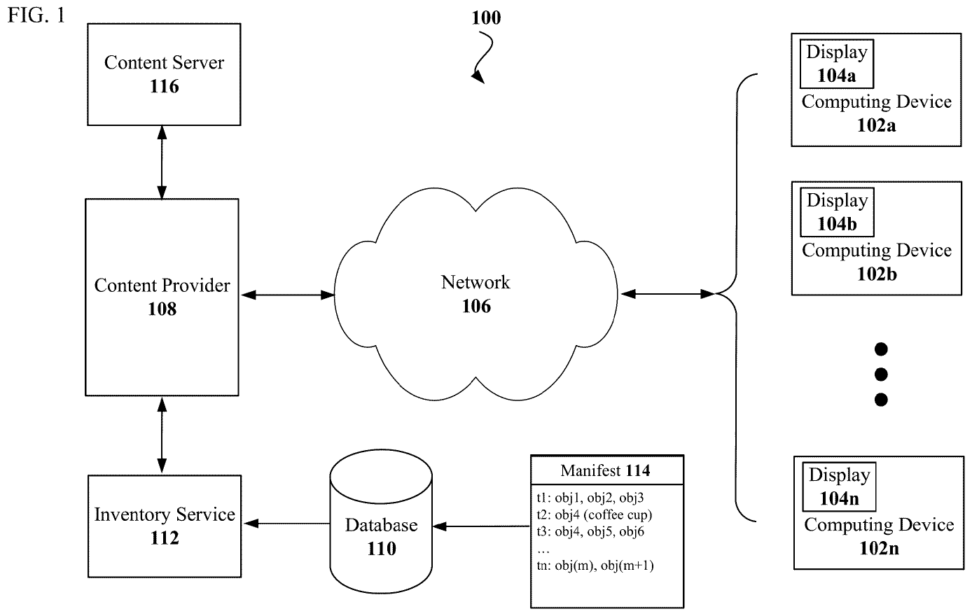

FIG. 1 shows an example system 100. The system 100 may comprise various computing devices 102a-102n. Each computing device 102a-102n may be a content presentation device comprising a display, such as display 104a-104n. A content presentation device may generally include any device now known to those having ordinary skill in the art or developed in the future that is capable of presenting content assets to a user or other type of content consumer. Non-limiting examples of content presentation devices include televisions, smart televisions, laptops, personal digital assistants (PDAs), tablet computing devices, smartphones, personal computers (PCs), display monitors or terminals, radios, audio devices, speakers, headphones, haptic devices, electronic reading devices (“e-readers”), light emitting diode (LED) devices, organic LED (OLED) devices, wearable screens, set-top-boxes, satellite receivers, video-on-demand (VOD) receivers, content receivers, digital video recorders (DVRs), personal video recorders (PVRs), hard drives, flash drives, storage servers, digital video disc (DVD) devices, or the like. A user, recipient, viewer, audience member, or the like may generally include an individual viewing, consuming, recording, streaming, or otherwise interacting with a content asset using a content presentation device.

The computing devices 102a-102n may be configured to host an application that a user may use to facilitate access to a service or content provided by a service provider. For example, the application may comprise a video streaming client that may connect to a server of a service provider, via a network operated by the service provider, in order to request and receive content from the service provider. For example, the computing devices 102a-102n may be configured to receive recorded content in a base media file format (BMFF), in a standard format determined by the Moving Picture Experts Group (MPEG), such as a transport stream (TS) defined by MPEG, for example MPEG-TS, or the like. The user device 102 may be configured to receive the content and output the content (e.g., playback) for consumption by the user. The computing devices 102a-102n may be configured to receive live streamed content and output the live streamed content, for example, a live broadcast of a football game.

The computing devices 102a-102n may be configured to communicate with a content service provider network, such as network 106. The computing devices 102a-102n may communicate with the network 106 via any of a variety of communications mediums, such as a coaxial cable network, a fiber-optic cable network, a hybrid fiber-coaxial (HFC) network, a satellite transmission channel, or the like. When part of a cable television system, the network 106 may comprise a cable modem termination system (CMTS).

The network 106 may provide various services to user devices, such as the computing devices 102a-102n, and may include the appropriate infrastructure for these services. For example, the network 106 may include one or more network routers (not shown). The network routers may comprise one or more edge routers, which may provide connectivity to other networks, including the Internet, a telephone network, or the like.

The network 106 may provide user devices, such as the computing devices 102a-102n, with access to a content service provider, such as content provider 108, which may comprise one or more content servers, such as content server 116, that are configured to send, e.g., stream, content to such user devices. The content server(s) may be configured to send, to a user device and based on a request from the user device, a variety of different types of content, including live content, video-on-demand content, advertisements, supplement content, or other content.

A content asset (or “content”) may generally include any type of data, information, media, or the like that may be expressed through a medium. Illustrative mediums may include audio and visual mediums such as television, radio, and broadcast, cable, satellite, and/or network (e.g., the Internet) forms thereof. Examples of content may include, but are not limited to, video, audio, movies, video games, television and radio programs, commercials, websites, images, photographs, text, electronic or digital documents, information feeds, streaming media, social media, social networks, and/or combinations thereof. Content may include an advertisement, such as a television advertisement or an online advertisement including, without limitation, website advertisements, Internet advertisements, search engine marketing (SEM), social media marketing, and mobile device advertising.

The content assets may be distributed or broadcast by a content service provider, such as content provider 108, to various content presentation devices and/or user devices, such as computing devices 102a-102n. A content service provider may generally include any type of entity or structure capable of providing content assets to a content presentation device. For instance, the content service provider may include a television broadcast network, a cable television network, a satellite television network, an internet service provider (ISP), a computing device advertising network, a media distribution network, a cloud computing network, a local area network (LAN), a wide area network (WAN), a terrestrial network, a mobile network, and/or any combination thereof. Television networks may include standard definition (SD) and high definition (HD) networks.

Non-limiting examples of content assets include messages, entertainment programming, and/or informational programming available over any type of applicable medium, including, but not limited to, television, radio, and electronic communication media (for example, Internet web sites, software applications, including mobile applications, “mobile apps” or “apps”).

Content service providers, such as content provider 108, may make content such as television and movie content available for output to one or more users, viewers, or audience members via a content presentation device, such as the computing devices 102a-102n, on a display, such as displays 104a-104n. A content service provider may additionally or alternatively determine to cause output of supplemental content to the one or more audience members. The supplemental content may comprise one or more advertisements, such as advertisements for clothing, electronics, upcoming television and movie releases, as well as products and services offered by the content providers themselves. It is understood that the supplemental content may comprise any type of content that is capable of being output to the one or more users, viewers, or audience members.

Content provider 108 may be configured to operate across physical device platforms, networks, and/or service providers simultaneously. For example, a content originator, such as content server 116, may send content provider 108 content assets, and an advertising content originator, such as inventory service 112, may send a distribution schedule thereof, such as an advertising campaign, to be managed by the content provider 108 and to be provided to the computing devices 102a-102n over network 106. For example, content provider 108 may distribute content assets and supplemental content to set-top-boxes over a cable television system, mobile computing devices using standard network communication protocols (for instance, Ethernet or Wi-Fi) over an Internet service provider network, and/or to smart phone devices over standard telecommunication protocols (for instance, 3G, 4G, 5G, LTE, or the like). The content provider 108 may comprise one or more machine learning models, pattern matching tools, artificial intelligence agents, or the similar tools for runtime object detection in videos.

A content originator, such as content server 116, may include any entity capable of providing content assets for distribution by a content service provider, such as content provider 108. A content originator may include any type of content developer known to those having ordinary skill in the art, such as an advertiser, an advertising agency, a television studio or broadcast network, a radio channel, a website provider, a VOD service, a content storage and delivery service, or the like.

An advertiser content originator, such as inventory service 112, may have advertisement content assets associated with one or more products or brands that they seek to have distributed by a content service provider, such as content provider 108, according to advertisement content originator information, which may include, without limitation advertising campaign information, campaign goals and/or constraints, campaign target information, or the like. Goals are typically expressed as a combination of budget and reach and frequency of exposure targets. Typically, the content originator (or “buyer”) may attempt to meet, or get as close as possible to, the campaign goals while staying within budget. The content originator and/or content service provider may look at various information, such as ratings data, inventory pricing, and commercial or TV spot rotations, to derive an optimal allocation of inventory against the goals. This process may be performed for a single product with a single advertisement, or for a single product with multiple advertisement (for example, with different target demographic audiences), for multiple products (for example, with each product being associated with one or more advertisements), for multiple advertisers (for example, with one or more advertisements each), or various combinations thereof.

A campaign may generally refer to a series of content presentations (e.g., “creatives”) generally related by a common idea or theme. An illustrative campaign may include an advertising campaign associated with various advertisements involving a common product or service. Advertisers may have several campaigns running simultaneously. Each campaign may be multiple weeks in length, during which advertisers'creatives, targeting, and daily budget may change.

An advertising content originator, such as inventory service 112, may purchase a large set of inventory (e.g., time slots on a television station, display elements, such as a banner advertisement, on a web page, etc.) and provide content originator information, such as the manifest 114, relating to mapping the campaign content assets onto the purchased inventory to a content service provider, such as content provider 108.

Inventory may generally include available recipients at one or more particular times. Some inventory may comprise a plurality of inventory slots, with each slot including one or more targets at a particular time. For example, an inventory slot may comprise a set of set-top-boxes within a cable network during prime time viewing hours on a particular television channel. Each inventory slot may be associated with a value or price indicating the cost associated with placing content therein.

The inventory may be stored on a database, such as database 110. Along with the inventory, one or more manifests, such as manifest 114, may also be stored in the database 110. Each manifest may include a list of objects mapped to each frame of a content asset. For example, frame t1 may display objects obj1, obj2, and obj3 within the frame. An example of an object displayed within a frame may be a coffee cup. Each content asset distributed by the content provider 108 may have an associated manifest related to it and stored in database 110. An advertising content originator, such as inventory service 112, may use a manifest, such as manifest 114, to map the objects in a frame of a content asset to supplemental content, such as an advertisement, advertising campaign, a brand, a set of inventory, and/or the like. The content provider 108 may send the mapped supplemental content with the content asset it is mapped to, provided by content server 116, over the network 106 to one or more computing devices, such as computing devices 102a-102n, to be output on a display, such as displays 104a-104n.

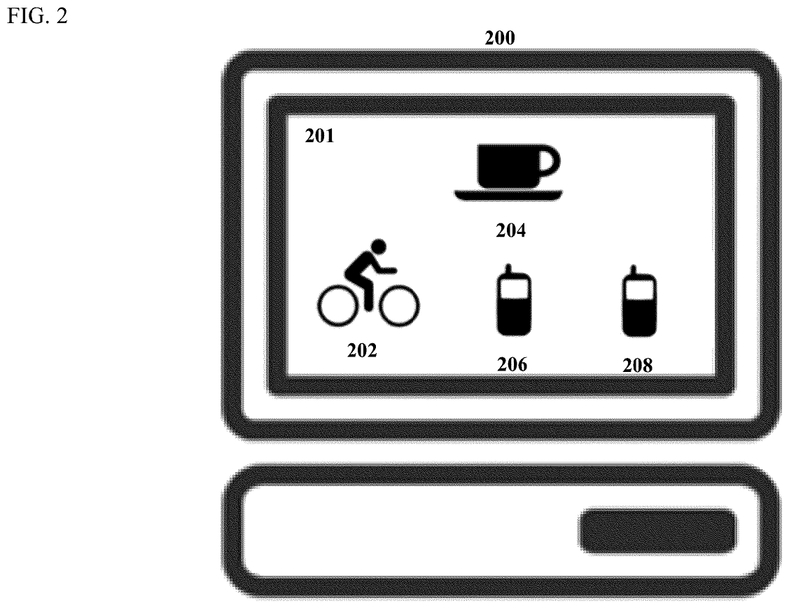

FIG. 2 shows an example of a frame 201 of a content asset output on a display 200. Display 200 may be a display of a content presentation device, such as display 104a-104n associated with computing devices 102a-102n of FIG. 1. The frame 201 may contain multiple objects within it such as objects 202, 204, 206, and 208. For example, object 204 is a coffee cup. The objects 202, 204, 206, and 208 may be mapped to supplemental content, such as an advertisement, an advertisement campaign, a brand, a set of inventory, and/or the like, by an advertising content originator, such as inventory service 112 in FIG. 1. The frame 201 which contains object 204 may be evaluated and input into a manifest, such as manifest 114, by the inventory service 112 in FIG. 1 and stored in a database, such as database 110 in FIG. 1. For example, frame 201 and object 204 may be stored as t2: obj4 (coffee cup) as shown in manifest 114 of FIG. 1. The evaluation of the frame, input into the manifest, and storage into a database may be conducted during runtime. The content presentation device may store information related to the frame such as the content asset associated with the frame, the time the frame is to be displayed during the output of the content asset, and/or other metadata related to the content asset and/or the frame of content asset. The content presentation device may send this information related to the frame to a content provider, such as content provider 108. The information may be sent in combination or as part of a request for an advertisement.

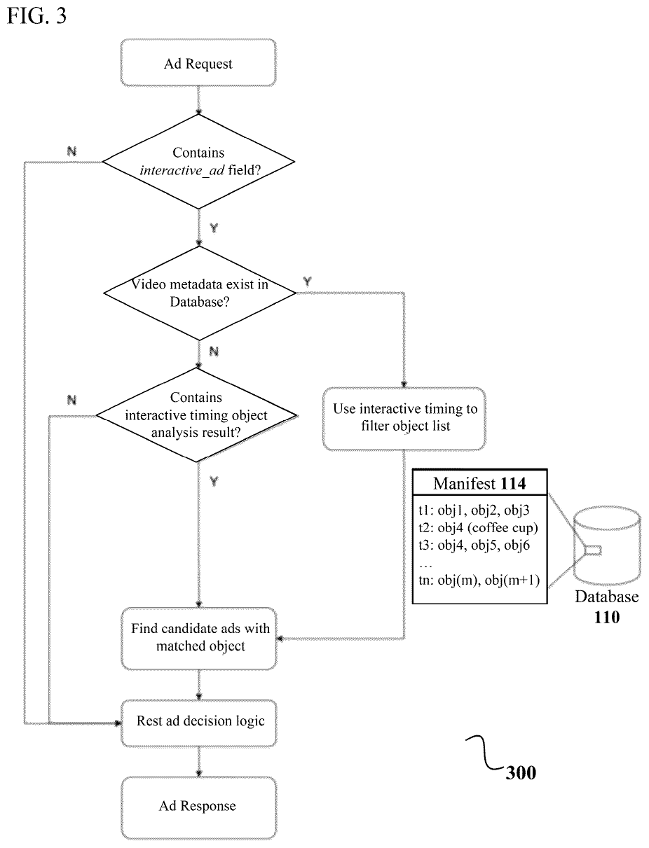

FIG. 3 shows a flow diagram of an example method 300 for advertisement decision making. The method 300 may be performed by a content service provider, such as content provider 108, a user device or content presentation device, such as the computing devices 102a-102n, or any such computing device illustrated in FIG. 1.

The device performing the method may generate an advertisement request. The request may be sent based on the user pausing the content being displayed on the content presentation device. Alternatively, the request may be sent based on embedded advertisement slots in the content asset. The device performing the method may determine that the request contains a field, such as an interactive_ad field. The field may indicate that the advertisement request may be associated with the interactive advertisement brand targeting methods disclosed herein, in order for the device performing the method to understand that such methods should be used. If the request does not contain the interactive_ad field, the advertisement decision making may be completed and the deice performing the method may send an advertisement response based on other methods not disclosed herein.

If the request does contain an interactive_ad field, the device performing the method may determine if video (or other type of content) metadata exists in a database, such as database 110 associated with inventory service 112 of FIG. 1.

The video (or other type of content) metadata may not exist in database 110. For example, a user may interact (i.e., pause the video) with the video at time t2. The device performing the method may use the time of the user interaction (interactive timing), time t2, to determine if a manifest contains information related to objects at time t2. If there are no objects that correspond to time t2, then there is no video metadata for time t2. Then the device performing the method may determine in real time the objects in the frame of the video (or other type of content) at the time the request was sent, for example time t2 or another recently viewed frame of the video (or other type of content), for example time t1.

Once the one or more objects are determined, the device performing the method may instruct an advertisement content originator, such as the inventory service 112 in FIG. 1, to determine a candidate ad that matches with an object in the frame. The candidate ad may be supplemental content, such as an advertisement, that correlates and/or matches with one of the objects identified within the frame of content. The advertisement content originator may be its own entity like inventory service 112 or may be part of the device performing the method. The determination may be based on one or more factors such as an advertising campaign, a brand, a set of inventory, an inventory slot, how recent an advertisement was output, and/or the like. If no objects are determined to be in the frame, for example the paused frame is purely one color with no objects within the frame, advertisement recommendations may still be used based on the above factors.

Once the supplemental content is determined, the device performing the method may complete the advertisement decision making process and send the supplemental content to the content presentation device for output.

If the video (or other type of content) metadata does exist in database 110, for example a manifest, such as manifest 114 in FIG. 1, that maps each object in each frame of the content exists and is stored in the database 110, then the device performing the method may use interactive timing to filter the manifest in order to determine candidate ads that match with the objects in each frame. The device performing the method may instruct an advertisement content originator, such as the inventory service 112 in FIG. 1, to determine supplemental content, such as an advertisement, that correlates and/or matches with one of the objects identified in the manifest associated with the content, such as obj 1 (brand 1) in manifest 114. The advertisement content originator may be its own entity like inventory service 112 or may be part of the device performing the method. This determination may be based on determining the most relevant advertisements or supplement content of one or more advertisements or supplement content related to the one or more objects that are determined to be in the frame. The determination may be based on one or more factors such as an advertising campaign, a brand, a set of inventory, an inventory slot, how recent an advertisement was output, and/or the like.

Once the candidate ad is determined, the advertisement decision making process may be completed and the device performing the method may send the supplemental content to the content presentation device for output.

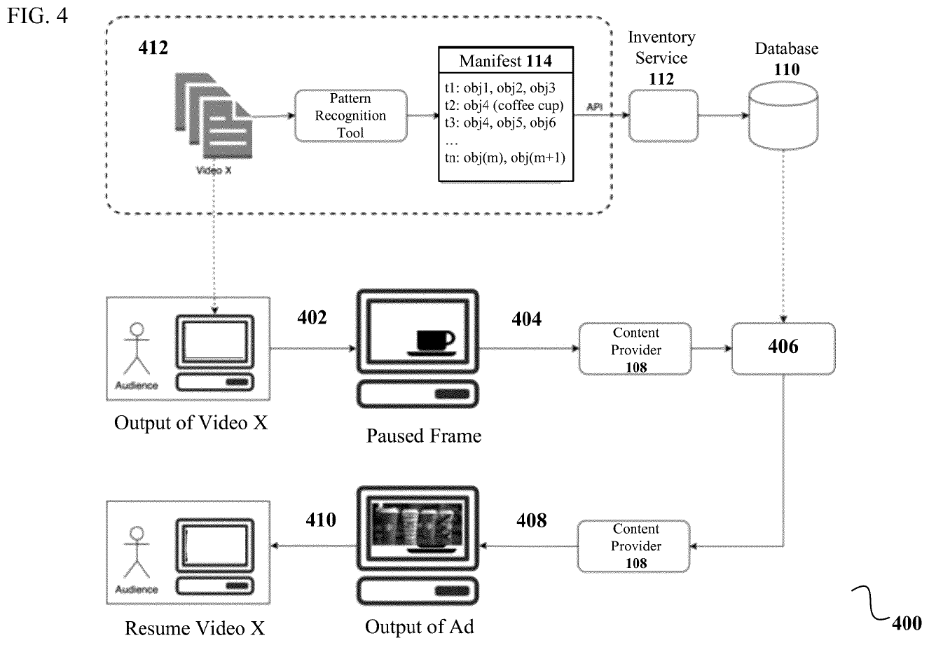

FIG. 4 shows an example flow diagram 400 of an example method for interactive advertisement brand targeting. At step 402, a user (e.g., the audience stick figure in FIG. 4) may be watching the output of video X on a content presentation device, such as computing devices 102a-102n and the associated displays 104a-104n in FIG. 1. The user may determine to pause the video X. When video X is paused, the output of video X will remain on a single frame until it is resumed. For example, FIG. 2 may represent a paused frame 201 of a content asset (e.g., video X) output on a display 200 (e.g., a content presentation device, such as computing devices 102a-102n and the associated displays 104a-104n). The paused frame may contain one or more objects, such as a coffee cup, within the frame.

At step 404, the content presentation device may send an advertisement request to a content service provider, such as content provider 108 in FIG. 1. The advertisement request may contain a field, such as an interactive_ad field, that indicates that the advertisement request may be associated with the interactive advertisement brand targeting methods disclosed herein, in order for the content provider 108 to understand that such methods should be used.

At step 406, the content provider 108 may use an advertisement decision making method such as the method 300 described in FIG. 3. For example, the inventory service 112 and associated database 110 in FIG. 1 may be used to determine the objects in the paused frame. The inventory service 112 may be its own entity or may be a part of the content provider 108. Prior to the output of video X, at step 412, video X may be analyzed using a pattern recognition tool to determine one or more objects in each frame of video X. Each of the one or more objects may be associated with or mapped to the frame in which the one or more objects appears. The association or mapping of the one or more objects with each frame of the video the object appears within may be stored in a manifest, such as manifest 114 in FIG. 1. The inventory service 112 may access the manifest 114 stored in a database, such as database 110 in FIG. 1, by using an application programming interface (API) or other similar methods.

One or more advertisements may be available for the inventory service 112 from which to choose an advertisement from. The inventory service 112 may determine an advertisement based on which advertisement of the one or more available advertisements is a relevant advertisement. An advertisement may be relevant based on the associations or mappings in the manifest. For example, a coffee shop advertisement may be a relevant advertisement based on the paused frame containing a coffee cup from that coffee shop, and an ongoing advertisement campaign for that coffee shop. Multiple advertisements may be relevant based on multiple advertisement campaigns or based on multiple objects being associated with or mapped to the paused frame. If no objects are determined to be in the frame, for example the paused frame is purely one color with no objects within the frame or if multiple advertisements are relevant, determining the advertisement may be made based on other advertisement factors, such as an advertising campaign, a brand, a set of inventory, an inventory slot, how recent an advertisement was output, and/or the like. The use of method 300 by the content provider 108 is not meant to be limiting and other methodology may be used to determine a relevant advertisement.

The content provider 108 may receive an indication of the relevant advertisement based on the advertisement decision making method 300, other methods described herein, or another method not listed, from the inventory service. The content provider 108 may send a request for the relevant advertisement based on the received indication to a content server, such as content server 116 in FIG. 1. The content provider 108 may receive the relevant advertisement from the content server 116. The content server 116 may its own entity or may be part of the content provider 108.

At step 408, the content provider 108 may send the relevant advertisement to the content presentation device for output. The advertisement may be output over the paused frame of video X. At step 410 the advertisement may be complete, or otherwise removed by the user, and video X may be resumed. The resumption of video X may be automatic, based on user input, or other similar method of resumption.

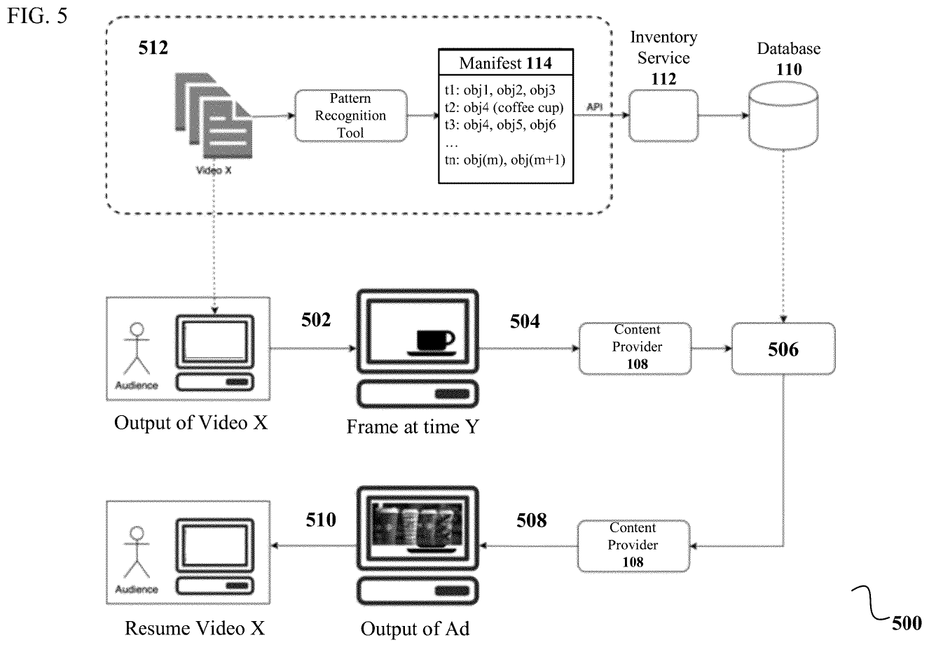

FIG. 5 shows an example flow diagram 500 of an example method for interactive advertisement brand targeting. At step 502, a user (e.g., the audience stick figure in FIG. 5) may be watching the output of video X on a content presentation device, such as computing devices 102a-102n and the associated displays 104a-104n in FIG. 1. The video X may have an embedded advertisement slot to be displayed at time Y. When video X reaches time Y, the frame of video X at time Y may be analyzed for an advertisement request. For example, FIG. 2 may represent the frame 201 of a content asset (e.g., video X) output on a display 200 (e.g., a content presentation device, such as computing devices 102a-102n and the associated displays 104a-104n) at time Y. The frame of video X at time Y may contain one or more objects, such as a coffee cup, within the frame. Alternatively, when video X reaches time Y, any of the past few seconds of frames may be analyzed for an advertisement request rather than the frame at time Y.

At step 504, the content presentation device may send an advertisement request to a content service provider, such as content provider 108 in FIG. 1. The advertisement request may contain a field, such as an interactive_ad field, that indicates that the advertisement request may be associated with the interactive advertisement brand targeting methods disclosed herein, in order for the content provider 108 to understand that such methods should be used.

At step 506, the content provider 108 may use an advertisement decision making method such as the method 300 described in FIG. 3. For example, the inventory service 112 and associated database 110 in FIG. 1 may be used to determine the objects in the frame of video X at time Y. The inventory service 112 may be its own entity or may be a part of the content provider 108. Prior to the output of video X, at step 412, video X may be analyzed using a pattern recognition tool to determine one or more objects in each frame of video X, including the frame of video X at time Y. Each of the one or more objects may be associated with or mapped to the frame in which the one or more objects appears in. The association or mapping of the one or more objects with each frame of the video the object appears within may be stored in a manifest, such as manifest 114 in FIG. 1. The inventory service 112 may access the manifest 114 stored in a database, such as database 110 in FIG. 1 by using an application programming interface (API) or other similar methods.

One or more advertisements may be available for the inventory service 112 to choose an advertisement from. The inventory service 112 may determine an advertisement based on which advertisement of the one or more available advertisements is a relevant advertisement. An advertisement may be relevant based on the associations or mappings in the manifest. For example, a Dunkin'® advertisement may be a relevant advertisement based on the frame of video X at time Y containing a coffee cup and an ongoing Dunkin'® advertisement campaign. Multiple advertisements may be relevant based on multiple advertisement campaigns or based on multiple objects being associated with or mapped to the paused frame. If no objects are determined to be in the frame, for example the paused frame is purely one color with no objects within the frame or if multiple advertisements are relevant, determining the advertisement may be made based on other advertisement factors, such as an advertising campaign, a brand, a set of inventory, an inventory slot, how recent an advertisement was output, and/or the like. The use of method 300 by the content provider 108 is not meant to be limiting and other methodology may be used to determine a relevant advertisement.

The content provider 108 may receive an indication of the relevant advertisement based on the advertisement decision making method 300, other methods described herein, or another method not listed, from the inventory service. The content provider 108 may send a request for the relevant advertisement based on the received indication to a content server, such as content server 116 in FIG. 1. The content provider 108 may receive the relevant advertisement from the content server 116. The content server 116 may its own entity or may be part of the content provider 108.

At step 508, the content provider 108 may send the relevant advertisement to the content presentation device for output. The advertisement may be output over the frame of video X at time Y. At step 510 the advertisement may be complete, or otherwise removed by the user, and video X may continue being output.

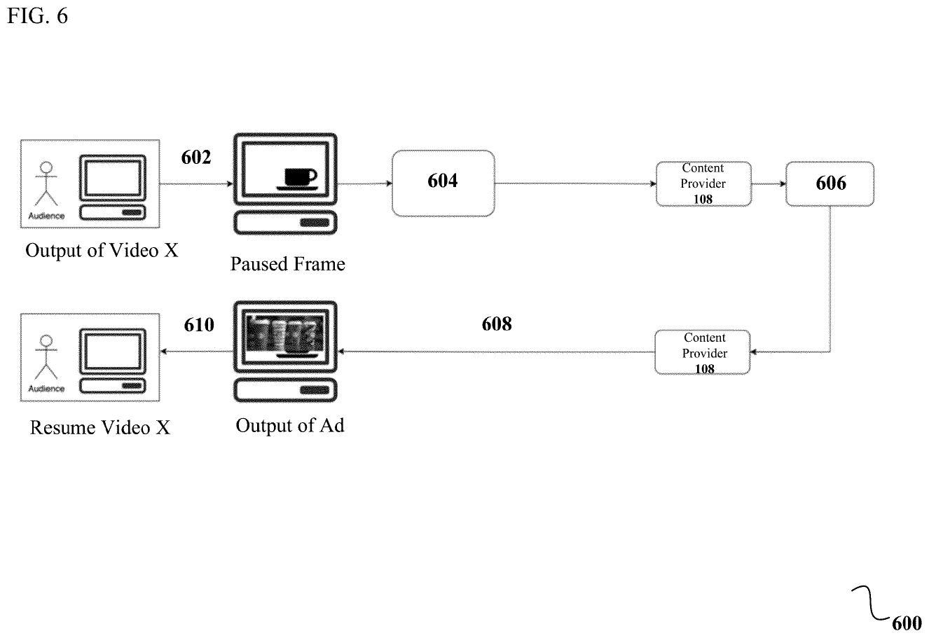

FIG. 6 shows an example flow diagram 600 of an example method for interactive advertisement brand targeting. At step 602, a user (e.g., the audience stick figure in FIG. 6) may be watching the output of video X on a content presentation device, such as computing devices 102a-102n and the associated displays 104a-104n in FIG. 1. The video may be a live stream video. The user may determine to pause the video X. When video X is paused, the output of video X will remain on a single frame until it is resumed. For example, FIG. 2 may represent a paused frame 201 of a content asset (e.g., video X) output on a display 200 (e.g., a content presentation device, such as computing devices 102a-102n and the associated displays 104a-104n). The paused frame may contain one or more objects, such as a coffee cup, within the frame.

At step 604, a content service provider, such as content provider 108, may use runtime object detection methods to determine the objects in the paused frame. The runtime object detection methods may be based on machine learning models, pattern matching tools, artificial intelligence agents, or similar tools to help detect the object in the paused frame.

The content presentation device may send an advertisement request to a content service provider, such as content provider 108 in FIG. 1. The advertisement request may contain a field, such as an interactive_ad field, that indicates that the advertisement request may be associated with the interactive advertisement brand targeting methods disclosed herein, in order for the content provider 108 to understand that such methods should be used.

At step 606, the content provider 108 may use an advertisement decision making method such as the method 300 described in FIG. 3. One or more advertisements may be available for the content provider 108 to choose an advertisement from. The content provider 108 may determine an advertisement based on which advertisement of the one or more available advertisements is a relevant advertisement. An advertisement may be relevant based on one or more of the objects identified within the frame of content by the runtime object detection method in step 604. The determination may be based on one or more factors such as an advertising campaign, a brand, a set of inventory, an inventory slot, how recent an advertisement was output, and/or the like. For example, a coffee shop advertisement may be a relevant advertisement based on the paused frame containing a coffee cup from that coffee shop and an ongoing advertisement campaign for that coffee shop. Multiple advertisements may be relevant based on multiple advertisement campaigns or based on multiple objects being associated with or mapped to the paused frame. If no objects are determined to be in the frame, for example the paused frame is purely one color with no objects within the frame or if multiple advertisements are relevant, advertisement recommendations may be made based on other advertisement factors, such as an advertising campaign, a brand, a set of inventory, an inventory slot, how recent an advertisement was output, and/or the like. The use of method 300 by the content provider 108 is not meant to be limiting and other methodology may be used to determine a relevant advertisement.

The content provider 108 may receive an indication of the relevant advertisement based on the advertisement decision making method 300, other methods described herein, or another method not listed. The content provider 108 may send a request for the relevant advertisement based on the received indication to a content server, such as content server 116 in FIG. 1. The content provider 108 may receive the relevant advertisement from the content server 116. The content server 116 may be its own entity or may be part of the content provider 108.

At step 608, the content provider 108 may send the relevant advertisement to the content presentation device for output. The advertisement may be output over the paused frame of video X. At step 610 the advertisement may be complete, or otherwise removed by the user, and video X may be resumed. The resumption of video X may be automatic, based on user input, or other similar method of resumption.

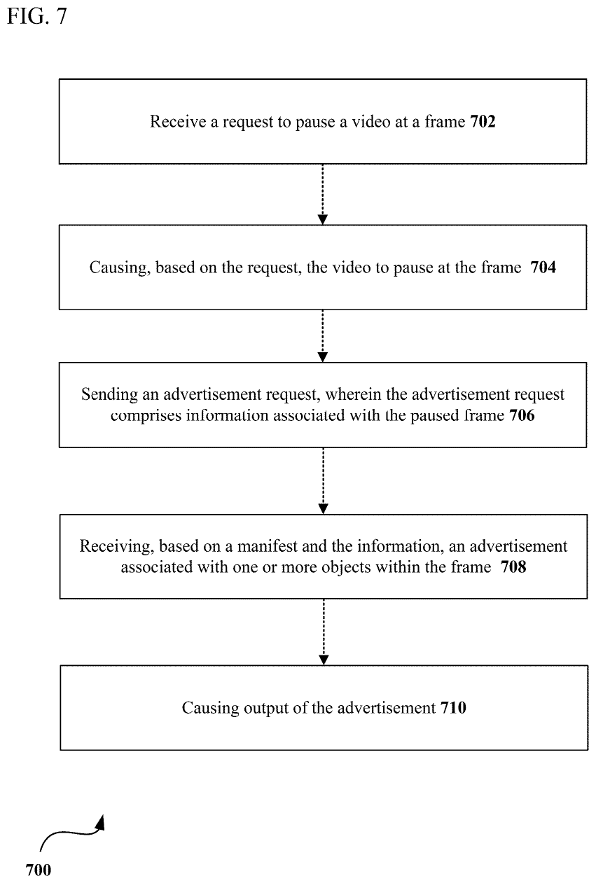

FIG. 7 shows an example method 700. The method 700 may be employed in the system illustrated in FIG. 1. The method 700 may be implemented as part of or in combination with the method illustrated in FIGS. 3, 4, 5, and/or 6. The method 700 may be performed by a content service provider, such as content provider 108, a user device or content presentation device, such as the computing devices 102a-102n, or any such computing device illustrated in FIG. 1.

In step 702, device performing the method may receive a request to pause a video at a frame. The video may be a video stream comprising one or more frames. At step 704, the request may cause the video to pause at the frame. The pausing of the frame may generate an advertisement request for an advertisement to be displayed over the paused frame.

At step 706, the device performing the method may send an advertisement request. The advertisement request may comprise information associated with the paused frame. The information associated with the paused frame may comprise information associated the video, a time associated with the output of the paused frame, metadata associated with the frame, or any other information needed to help determine objects within the frame.

At step 708, the device performing the method may receive an advertisement associated one or more objects within the paused frame. Determining the one or more objects within the frame may comprise determining one or more objects within each frame of the video based on a pattern recognition tool, and selecting from the determined one or more objects, the one or more objects associated with the paused frame. Determining the one or more objects within the frame may comprise determining a manifest, wherein the manifest associates each frame of the video with the one or more objects in that frame, and selecting from the manifest, the one or more objects associated with the paused frame.

The device performing the method may receive the advertisement by communicating with an inventory service, such as inventory service 112 illustrated in FIG. 1. The inventory service or the device performing the method may select an advertisement from one or more advertisements may be. The determination may be based on which advertisement of the one or more available advertisements is a relevant advertisement. An advertisement may be relevant based on the associations or mappings in the manifest. For example, a coffee shop advertisement may be a relevant advertisement based on the paused frame containing a coffee cup from that coffee shop, and an ongoing advertisement campaign for that coffee shop. Multiple advertisements may be relevant based on multiple advertisement campaigns or based on multiple objects being associated with or mapped to the paused frame. If no objects are determined to be in the frame, for example the paused frame is purely one color with no objects within the frame or if multiple advertisements are relevant, advertisement recommendations may be made based on other advertisement factors, such as an advertising campaign, a brand, a set of inventory, an inventory slot, how recent an advertisement was output, and/or the like.

The advertisement may be based on the determination of the one or more objects within the paused frame. The advertisement may be determined based on determining the most relevant object of the one or more objects within the paused frame, which may be based on a database of advertisements and a list of previously used advertisements, and determining an advertisement associated with the most relevant object of the one or more objects within the paused frame. The device performing the method may determine the one or more objects within the paused frame and determine the advertisement recommendation in a similar manner as the inventory service 112.

At step 710, the device performing the method may cause output of the advertisement during the paused video. The content provider may update the database of advertisements and the list of previously used advertisements based on causing output of the advertisement. The device performing the method may receive a request from the user to resume the video. The resumption of the video may cause output of the advertisement to end and cause output of the video to resume.

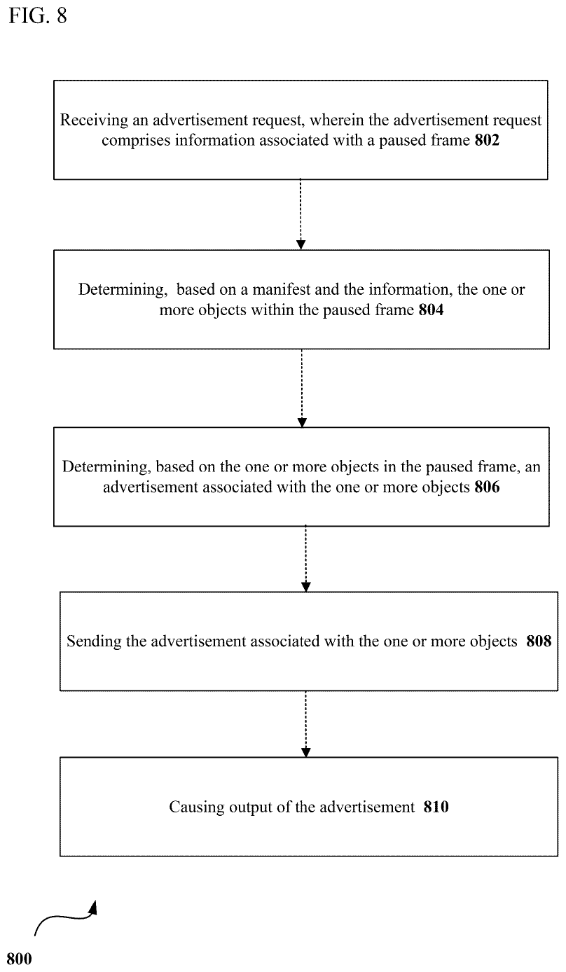

FIG. 8 shows an example method 800. The method 800 may be employed in the system illustrated in FIG. 1. The method 800 may be implemented as part of or in combination with the method illustrated in FIGS. 3, 4, 5, and/or 6. The method 800 may be performed by a content service provider, such as content provider 108, a user device or content presentation device, such as the computing devices 102a-102n, or any such computing device illustrated in FIG. 1.

At step 802, the device performing the method may receive an advertisement request. The request may be sent from a user device or content presentation device, such as computing devices 102a-n, or any such computing device illustrated in FIG. 1. The request may be sent based on a video being paused. The advertisement request may comprise information associated with the paused frame. The information associated with the paused frame may comprise information associated the video, a time associated with the output of the paused frame, metadata associated with the frame, or any other information needed to help determine objects within the frame.

At step 804, the device performing the method may determine one or more objects within the paused frame of the video. The one or more objects may be determined based on a manifest and the information associated with paused frame. Additionally, it may comprise generating a manifest. The manifest may associate each frame of the video with the one or more objects in the frame, and the device performing the method may select from the manifest, the one or more objects associated with the paused frame. Determining the one or more objects within the frame may comprise determining each object within each frame of the video based on a pattern recognition tool and selecting the one or more objects associated with the paused frame.

At step 806, a content provider 108 may determine the advertisement associated with the one or more objects. This determination may be based on the one or more objects within the paused frame and the request for the advertisement. The advertisement may be determined based on determining the most relevant one or more objects of the one or more objects within the frame, and determining an advertisement associated with the most relevant one or more objects. The most relevant one or more objects and advertisement associated with it may be determined based on a database of advertisements and a list of previously output advertisements.

At step 808, the device performing the method may send the advertisement associated with the one or more objects. The device performing the method may send the advertisement to the requesting device, which may be a user device or content presentation device for output. The user device or content presentation device may receive the advertisement associated with an object of the one or more objects within the paused frame.

At step 810, the reception of the advertisement and/or sending of the advertisement may cause output of the advertisement. The advertisement may be output during the paused video. The device performing the method may update the database of advertisements and the list of previously used advertisements based on causing output of the advertisement. The device performing the method may receive a request from to resume the video. The resumption of the video may cause output of the advertisement to end and cause output of the video to resume.

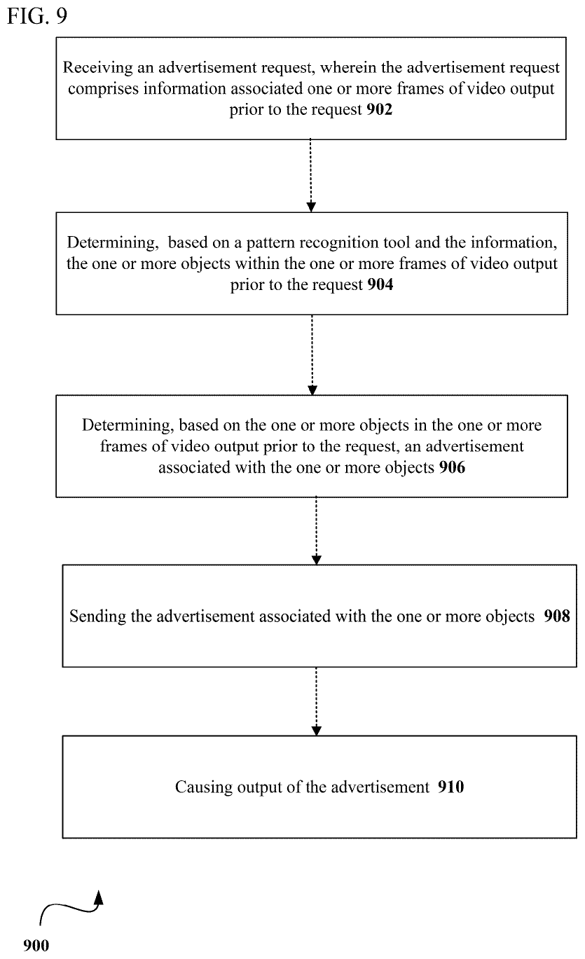

FIG. 9 shows an example method 900. The method 900 may be employed in the system illustrated in FIG. 1. The method 900 may be implemented as part of or in combination with the method illustrated in FIGS. 3, 4, 5, and/or 6. The method 900 may be performed by a content service provider, such as content provider 108, a user device or content presentation device, such as the computing devices 102a-102n, or any such computing device illustrated in FIG. 1.

At step 902, the device performing the method may receive an advertisement request. The request may be sent from a user device or content presentation device, such as computing devices 102a-n, or any such computing device illustrated in FIG. 1. The request may be sent based on an embedded advertisement slot. The advertisement request may comprise information associated with one or more frames of video output prior to the request. The information associated with the associated with one or more frames of video output prior to the request may comprise information associated the video, a time associated with the output of the one or more frames of video output prior to the request, metadata associated with the one or more frames of video output prior to the request, or any other information needed to help determine objects within the one or more frames of video output prior to the request. The one or more frames of the video output prior to the request comprises at least one of one minute of video frames, five minutes of video frames, ten minutes of video frames, and/or any other reasonable amount of video frames.

At step 904, the device performing the method may determine one or more objects within the one or more frames of video output prior to the request. The one or more objects may be determined based on a pattern recognition tool and the information associated with the one or more frames of video output prior to the request. Determining the one or more objects within the frame may comprise determining each object within each frame of the video based on a pattern recognition tool and selecting the one or more objects associated with the one or more frames of video output prior to the request. Additionally, it may comprise generating a manifest. The manifest may associate each frame of the video with the one or more objects in the frame, and the device performing the method may select from the manifest, the one or more objects associated with the one or more frames of video output prior to the request.

At step 906, a content provider 108 may determine the advertisement associated with the one or more objects. This determination may be based on the one or more objects within the one or more frames of video output prior to the request and the request for the advertisement. The advertisement may be determined based on determining the most relevant one or more objects of the one or more objects within the one or more frames of video output prior to the request, and determining an advertisement associated with the most relevant one or more objects. The most relevant one or more objects and advertisement associated with it may be determined based on a database of advertisements and a list of previously output advertisements.

At step 908, the device performing the method may send the advertisement associated with the one or more objects. The device performing the method may send the advertisement to the requesting device, which may be a user device or content presentation device for output. The user device or content presentation device may receive the advertisement associated with an object of the one or more objects within the one or more frames of video output prior to the request.

At step 910, the reception of the advertisement and/or sending of the advertisement may cause output of the advertisement. The advertisement may be output during over the video. The device performing the method may update the database of advertisements and the list of previously used advertisements based on causing output of the advertisement. The device performing the method may receive a request from to stop viewing the advertisement. The request to stop viewing of the advertisement may cause output of the advertisement to end and cause output of the video to resume.

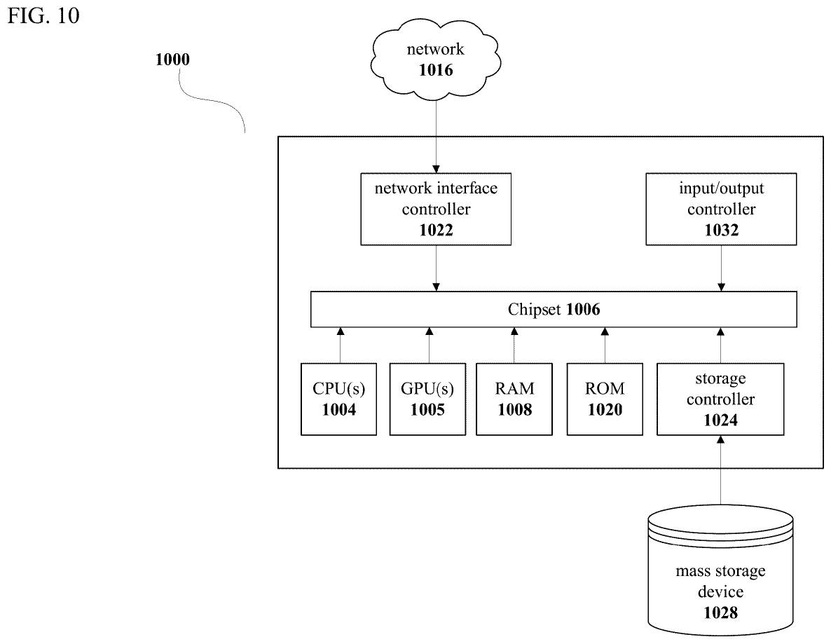

FIG. 10 shows an example computing device 1000 that may represent any of the various devices or entities shown in FIG. 1, including, for example, the computing device 102a-n and the server 108. The computing device 1000 shown in FIG. 10 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 2-9.

The computing device 1000 may comprise a baseboard, or “motherboard,” which is a printed circuit board to which a multitude of components or devices may be connected by way of a system bus or other electrical communication paths. One or more central processing units (CPUs or “processors”) 1004 may operate in conjunction with a chipset 1006. The CPU(s) 1004 may be standard programmable processors that perform arithmetic and logical operations necessary for the operation of the computing device 1000.

The CPU(s) 1004 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 1004 may be augmented with or replaced by other processing units, such as GPU(s) 1005. The GPU(s) 1005 may comprise processing units specialized for but not necessarily limited to highly parallel computations, such as graphics and other visualization-related processing.

A chipset 1006 may provide an interface between the CPU(s) 1004 and the remainder of the components and devices on the baseboard. The chipset 1006 may provide an interface to a random-access memory (RAM) 1008 used as the main memory in the computing device 1000. The chipset 1006 may provide an interface to a computer-readable storage medium, such as a read-only memory (ROM) 620 or non-volatile RAM (NVRAM) (not shown), for storing basic routines that may help to start up the computing device 1000 and to transfer information between the various components and devices. ROM 1020 or NVRAM may also store other software components necessary for the operation of the computing device 1000 in accordance with the aspects described herein.

The computing device 1000 may operate in a networked environment using logical connections to remote computing nodes and computer systems of the system 100. The chipset 1006 may comprise functionality for providing network connectivity through a network interface controller (NIC) 1022. A NIC 1022 may be capable of connecting the computing device 1000 to other computing nodes over the system 100. It should be appreciated that multiple NICs 1022 may be present in the computing device 1000, connecting the computing device to other types of networks and remote computer systems. The NIC 1022 may be configured to implement a wired local area network technology, such as IEEE 802.3 (“Ethernet”) or the like. The NIC 1022 may also comprise any suitable wireless network interface controller capable of wirelessly connecting and communicating with other devices or computing nodes on the system 100. For example, the NIC 1022 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 1000 may be connected to a mass storage device 1028 that provides non-volatile storage (i.e., memory) for the computer. The mass storage device 1028 may store system programs, application programs, other program modules, and data, which have been described in greater detail herein. The mass storage device 1028 may be connected to the computing device 1000 through a storage controller 1024 connected to the chipset 1006. The mass storage device 1028 may consist of one or more physical storage units. A storage controller 1024 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1000 may store data on a mass storage device 1028 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 1028 is characterized as primary or secondary storage or the like.

For example, the computing device 1000 may store information to the mass storage device 1028 by issuing instructions through a storage controller 1024 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1000 may read information from the mass storage device 1028 by detecting the physical states or characteristics of one or more particular locations within the physical storage units.

In addition to the mass storage device 1028 described herein, the computing device 1000 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1000.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 1028 depicted in FIG. 10, may store an operating system utilized to control the operation of the computing device 1000. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1028 may store other system or application programs and data utilized by the computing device 1000.

The mass storage device 1028 or other computer-readable storage media may also be encoded with computer-executable instructions, which, when loaded into the computing device 1000, transforms the computing device from a general-purpose computing system into a special-purpose computer capable of implementing the aspects described herein. These computer-executable instructions transform the computing device 1000 by specifying how the CPU(s) 1004 transition between states, as described herein. The computing device 1000 may have access to computer-readable storage media storing computer-executable instructions, which, when executed by the computing device 1000, may perform the methods described in relation to FIGS. 2-9.

A computing device, such as the computing device 1000 depicted in FIG. 10, may also comprise an input/output controller 1032 for receiving and processing input from a number of input devices, such as a keyboard, a mouse, a touchpad, a touch screen, an electronic stylus, or other type of input device. Similarly, an input/output controller 1032 may provide output to a display, such as a computer monitor, a flat-panel display, a digital projector, a printer, a plotter, or other type of output device. It will be appreciated that the computing device 1000 may not comprise all of the components shown in FIG. 10, may comprise other components that are not explicitly shown in FIG. 10, or may utilize an architecture completely different than that shown in FIG. 10.

As described herein, a computing device may be a physical computing device, such as the computing device 1000 of FIG. 10. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

1. A method comprising:
receiving, from a user device, a request to pause a video at a frame;
causing, based on the request, the video to pause at the frame;
sending, by a computing device, an advertisement request, wherein the advertisement request comprises information associated with the paused frame;
receiving, by the computing device and based on a manifest and information associated with the paused frame, an advertisement associated with one or more objects within the frame, wherein the manifest associates each frame of the video with each object in that frame; and
causing, by the computing device and based on receiving the advertisement, output of the advertisement.

2. The method of claim 1, wherein the information associated with the paused frame comprises information associated with at least one of:
the video;
a time associated with the output of the paused frame; and
metadata associated with the frame.

3. The method of claim 1, wherein the advertisement is output over the paused video.

4. The method of claim 1, wherein the video is a video stream comprising one or more frames.

5. The method of claim 1, further comprising:
receiving a request to resume the video;
causing output of the advertisement to end; and
causing output of the video to resume.

6. A method comprising:
receiving, by a computing device, an advertisement request, wherein the advertisement request comprises information associated with a paused frame of a video;
determining, by the computing device and based on a manifest and the information associated with the paused frame, one or more objects within the paused frame of the video, wherein the manifest associates each frame of the video with each object in that frame;
determining, based on the one or more objects in the paused frame and the request, an advertisement associated with the one or more objects;
sending, by the computing device, the advertisement associated with the one or more objects;
causing output of the advertisement.

7. The method of claim 6, wherein the determining the advertisement further comprises:
determining, based on a database of advertisements and a list of previously output advertisements, the most relevant one or more objects of the one or more objects within the frame; and
determining, based on the database of advertisements, an advertisement associated with the most relevant one or more objects of the one or more objects within the frame.

8. The method of claim 7, further comprising:
updating, based on the causing output of the advertisement, the database of advertisements and the list of previously output advertisements.

9. The method of claim 6, wherein the determining the one or more objects within the paused frame of the video further comprises selecting, from the manifest, the one or more objects associated with the paused frame.

10. The method of claim 6, wherein the information associated with the paused frame comprises information associated with at least one of:
the video;
a time associated with the output of the paused frame; and
metadata associated with the frame.

11. The method of claim 6, wherein the advertisement is output over the paused video.

12. The method of claim 6, wherein the video is a video stream comprising one or more frames.

13. A method comprising:
receiving, by a computing device, an advertisement request, wherein the advertisement request comprises information associated with one or more frames of video output prior to the request;
determining, by the computing device and based on a pattern recognition tool and the information associated with the one or more frames of the video output prior to the request, one or more objects within the one or more frames of the video output prior to the request;
determining, based on the one or more objects within the one or more frames of the video output prior to the request and the request, an advertisement associated with the one or more objects;
sending, by the computing device, the advertisement associated with the one or more objects; and
causing output of the advertisement.

14. The method of claim 13, wherein the determining one or more objects within the one or more frames of the video output prior to the request further comprises:
determining, based on a pattern recognition tool, each object within each frame of the video; and
selecting, from the determined each object within each frame of the video, the one or more objects associated the one or more frames of the video output prior to the request.

15. The method of claim 13, wherein the determining the advertisement further comprises:
determining, based on a database of advertisements and a list of previously output advertisements, the most relevant one or more objects of the one or more objects within the one or more frames of the video output prior to the request; and
determining, based on the database of advertisements, an advertisement associated with the most relevant one or more objects of the one or more objects within the one or more frames of the video output prior to the request.

16. The method of claim 15, further comprising:
updating, based on the causing output of the advertisement, the database of advertisements and the list of previously output advertisements.

17. The method of claim 13, wherein the information associated with the one or more frames of the video output prior to the request comprises information associated with at least one of:
the video;
a time associated with the output of the one or more frames of the video output prior to the request; and
metadata associated with the one or more frames of the video output prior to the request.

18. The method of claim 13, wherein the advertisement is output over the video.

19. The method of claim 13, wherein the video is a video stream comprising one or more frames.

20. The method of claim 13, wherein the one or more frames of the video output prior to the request comprises at least one of:
one minute of video frames;
five minutes of video frames; and
ten minutes of video frames.
